(19) United States
(12) Patent Application Publication
(10) Pub. No.: US 2008/0256479 A1
(43) Pub. Date: Oct. 16, 2008

(54) Electronic publication and methods and components thereof

(75) Inventor: Chris Hemmings, Hong Kong (HK)

Correspondence Address: JACOBSON HOLMAN PLLC, 400 SEVENTH STREET N.W., SUITE 600, WASHINGTON, DC, 20004, US

(73) Assignee: VIRTUAL PUBLISHING COMPANY LTD.

(21) Appl. No.: 11/819,985

(22) Filed: Jun. 29, 2007

Related U.S. Application Data
(62) Division of application No. 10/892,396, filed on Jul. 16, 2004.
Application No. 10/892,396 is a continuation of application No. 09/657,149, filed on Sep. 7, 2000, now abandoned.

(51) Int. Cl. G06F 3/048

(52) U.S. Cl. 715/776

(57) ABSTRACT

An electronic publication and methods and components thereof including a user interface. The electronic publication can be provided by e-mail or similar transmission add contains its own executable file for presentation of the publication without a user requiring a preloaded application software. The electronic publication addresses the processor for calculation and the operating system for increased functionality to minimize the size of the executable file and the publication as a whole. The publication contains a user interface incorporating a page-turn and provides a non-linear travel of the free edge of the tog page across a revealing page so as to imitate a substantially constant rotation of the page. The animation sequence throughout the page-turn is performed on the basis of actual elapsed time since commencement of the animation rather than at predetermined intervals so as to make the individual steps throughout the animation independent of the processor speed. The page-turn also incorporates a 3-dimensional representation by increasingly stretching the vertical axis of the rotating edge of the page as it approaches the central axis of rotation of the page.

### CROSS-REFERENCE TO RELATED APPLICATIONS

The present patent application is a division of application Ser. No. 10/892,396, filed Jul. 16, 2004, which is a continuation of application Ser. No. 09/657,149, filed Sep. 7, 2000, which are incorporated herein by reference in their entireties.

### FIELD OF THE INVENTION

This invention relates to an electronic publication and methods and components thereof. In particular, although not necessarily solely, this includes an electronic publication to simulate a book or magazine.

### BACKGROUND TO THE INVENTION

Electronic publications have existed for some considerable time. By far the largest source of electronic publication is the World Wide Web that allows access to a wealth of information and publications on almost any topic.

Although some Internet companies have provided magazine or newspaper style documents on the WWW, there has been little acceptance of such publications. Even the larger print publications and leading newspapers may provide an Internet version but do not use this as a substitute for the conventional print publication.

There are many reasons for the slow acceptance of the electronic medium by both publishers and readers. At the moment, the most universal method of allowing access to the publication is by the WWW. However, the medium has numerous restrictions on the document format that is inherent in the HTML scripts used to provide the web content. For example, the documents are not of standard length. Although the publisher may set a particular page length, the viewed length of page is also determined by the viewers own browser settings. As a result, the bottom of many web pages is not apparent without using the scroll bar for viewing. By this time, many viewers may have already decided to view a different page and not look at the bottom of the page of content. This space has become very undesirable by advertisers for this reason and far more leading banners are used.

This is but one example of a fundamental problem with the WWW and documents viewed through browsers. These various problems all ensure that a publisher has no assurance that the viewer will be seeing the page as intended. Problems with layout and useful advertising spare become prevalent.

Not only can a publisher be unsure of the viewer seeing the entire page but the browser settings and the limitations of HTML also mean that even the portion viewed may not come across to the viewer as intended. This also makes the whole reading experience less than that desired by the readers as well.

A further problem with WWW publications is a matter of speed. Each page requested by the viewer must be individually requested, received and displayed. The request and receipt both occur over the WWW and rely on communication speed and the speed, traffic and availability of the various servers involved in the transfer. Without opening multiple copies of the browser so a user can read one page while downloading the next, there is no practical way to ensure prompt availability of the next page.

The presentation, format and tools associated with the viewing of WWW documents are also a hindrance. With non-scalable fonts, limited format under html and the need to use scroll bars simply to view the existing page, the viewing experience is destroyed and print publications continue to dominate.

On this basis, a successful electronic publication needs to provide a document that is easily transmitted, is viewable by a large number of computer users or a targeted audience has an interface requiring the minimum of computer education and understanding and provides content in a consistent format as intended by the publisher.

To a large extent, it is desirable to have electronic publications emulate the current print publications as closely as is practicable.

One difficulty with attempting to emulate such existing print publications is due to the lack of a suitable user interface with the publication. Although electronic presentations have been provided that utilise multiple pages and provide a book-like presentation on the screen, previous animations of the page-turn mechanism have caused an artificial appearance to the document.

Various page-turn mechanism are described in such patents as U.S. Pat. Nos. 5,625,420; 4,860,217; 5,233,332; 5,053,762; 5,801,713; 5,900,876; 5,519,827 and 5,463,725. However, these do not render a particularly realistic page turn.

One of the aspects missing from such prior solutions is a realistic travel of the page across the screen. With a printed book, the page is lifted as it is turned so that the edge of the page as it turns is much closer to the reader. The progression of this leading edge of the page is not constant against the background. If the rotation is constant, it will be appreciated that the edge of the page moves much less across the page beneath at the start of the rotation than as it approaches the mid-point or position directly above the spine of the book as a function of time. A constant travel of this edge across the page beneath provides an artificial appearance that detracts from the interface. It leads to all artificial takeoff and landing of the turning page.

Another problem is that the rise of the edge and its rotation bringing the edge closer to the reader also makes that edge larger in height than the page beneath. Although some of the solutions provide some vertical shift to the moving page, the height of the moving page remains constant across its width. In reality this is not the case and the edge of the page closest to the reader needs to expand in the vertical direction or stretch to simulate reality. The edge of the page closest to the spine should receive no corresponding stretch and all points in between the edges need to move according to their proximity to the leading or static edges of the page.

A yet further problem with the previous page-turn solutions is in the manner of calculation of the animation. These prior art solutions generally involve an animation sequence that is set for the particular document format. If the scale of the document changes or it is desired to increase or decrease the speed of rotation, the animation is no longer accurate. This is generally due to a failure to recognize tat the geometric of curves involved in the page-turn and the ting of the animation are all linked and derived from a family of elliptical or circular curves. It is only upon this appreciation that the animation sequence can be provided with flexibility as the variable parameters in the animation sequence can all be predetermined by a user or self-derived from other equations.

A yet further disadvantage with prior art solutions is that the animation is largely dependent on the processor. It requires the timing of the processor to provide an accurate timing sequence to the animation itself. However, if the animation sequence can be calculated in real time independent of the processor itself, the speed of rotation and visual aspect of the animation will not be seriously affected by the processor performing other tasks or through the variation of processor speeds between one computer and another.

### OBJECT OF THE INVENTION

It is an object of the present invention to provide an electronic publication and method and components thereof that overcomes some of the disadvantages of the prior art by providing an alternative animation to the user interface.

Alternatively or additionally, it is an object to provide such an electronic publication in a manner that is transmittable without the use of a conventional browser.

It is a further additional or alternative object of the invention to provide an electronic publication and methods and components thereof that at least provide the public with a useful choice.

### SUMMERY OF THE INVENTION

Accordingly, in the first aspect, the invention may broadly be said to consist in an electronic publication comprising:

an executable application;

a publication document having a plurality of pages; and

wherein the application and publication form a unitary file in assembly code to address a compatible hardware processor directly and containing a plurality of commands to address sub-routines in a compatible operating system to provide the graphical output on a screen.

Preferably said hardware processor comprises a microprocessor in a computer or Internet device.

Preferably said operating system comprises a sole operating system for said hardware processor.

Preferably said processor comprises a PC compatible microprocessor.

Preferably said PC compatible microprocessor comprises an INTEL microprocessor or substantially similar or equivalent processor.

Preferably said operating system comprises a Microsoft Widows operating system.

Alternatively, said processor and operating system comprise an alternative compatible pairing.

Accordingly, in a second aspect, the invention may broadly be said to consist in a user interface including a page-turn for a multiple page document comprising:

a screen display of a first page of image or text;

detecting a request from a user for a subsequent page of image or text;

a page-turn comprising an animated sequence of frames displayed throughout the transition between said first and subsequent pages of image or text; and

wherein said animation reveals less of the subsequent page beneath the first page at the commencement of the animation with respect to time than when the first page approaches a position representing the page orthogonal to the axis of rotation of the first page.

Preferably the position of the first page in a frame of said animation is calculated with respect to elapsed time during a predetermined total time for completion of the page-turn.

Preferably said predetermined time for completion of the page-turn is selectable by a user.

Preferably an edge of said turning page distal from said centre of rotation increasingly stretches along an axis parallel to said axis of rotation as said edge approaches the axis of rotation.

Preferably said first page is represented as a convex surface when travelling between a starting position and the position in line with the centre of rotation of the first page.

Accordingly, in a third aspect, the invention may broadly be said to consist in computer software program to provide the electronic publication and/or the user interface as previously defined.

### BRIEF DESCRIPTION OF THE DRAWINGS

Preferred embodiments of the invention will now be described with reference to the following drawings in which:

FIG. 1 is a schematic diagram of a user interface providing a page-turn during rotation;

FIG. 2 shows a geometric diagram used to explain movements in the animation sequence of a page-turn;

FIG. 3 shows a representation of the buffers used in the animation process;

FIG. 4 shows a screen shot of a page of a publication in accordance with a preferred embodiment of the invention;

FIGS. 5 to 8 show sequential series of screen shots of the user interface during a page-turn rotation;

FIG. 9 is a flowchart of the method and operations of a program to provide the user interface;

FIG. 10 is a flowchart of the frame output calculation on FIG. 9;

FIG. 11 is a flowchart of the calculation of horizontal and vertical pixel movement referred to in FIG. 10;

FIG. 12 is a flowchart of the sequence of updating pixel rows to the duplicate ghost buffer referred to in FIG. 10;

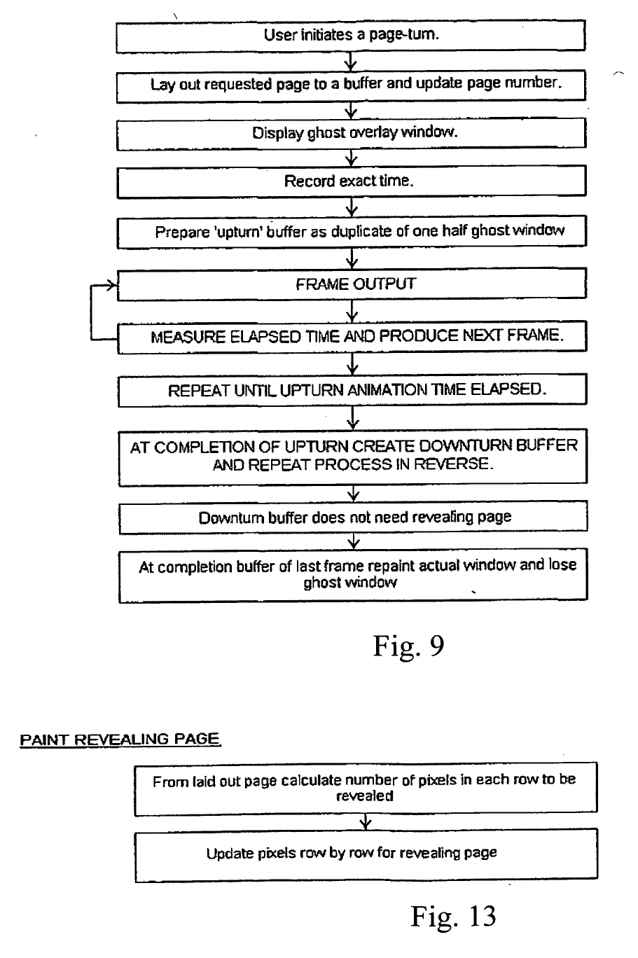

FIG. 13 is a flowchart of the operations to paint the revealing page; and

FIG. 14 is a flowchart of the events to send the ghost duplicate buffer containing the animation step for display to the screen.

### DETAILED DESCRIPTION OF PREFERRED EMBODIMENTS

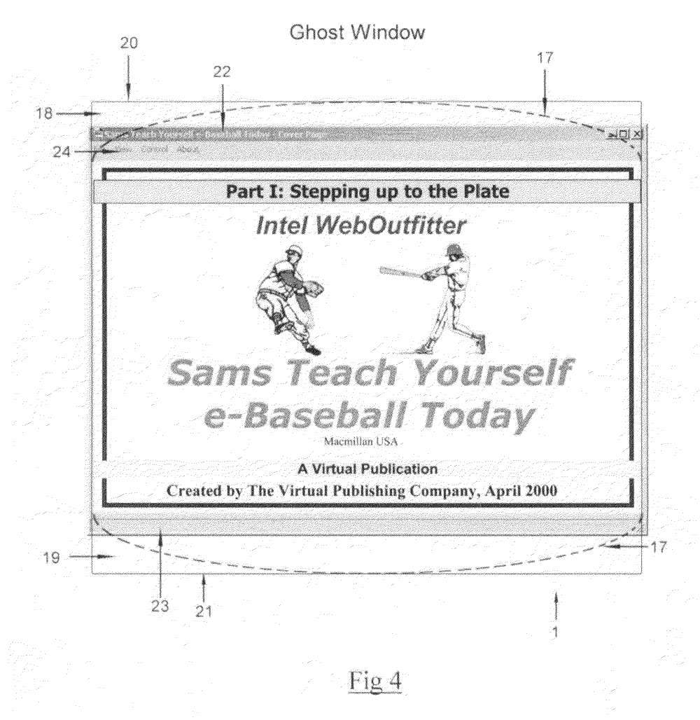

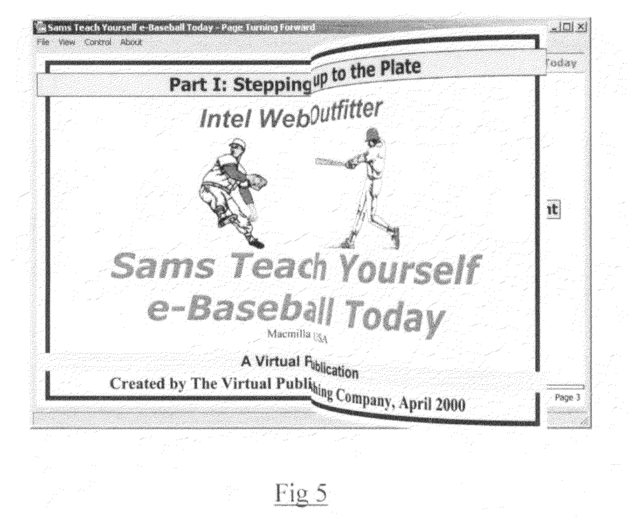

This invention relates to an electronic publication in the form of a multi-page document. An example of the publication 1 is shown in FIG. 4 with further examples of an animated page-turn between various pages of the application shown in FIGS. 5 to 8.

The electronic publication 1 is provided to layout both text and images to a viewer on a screen display. Typically, the electronic publication would be viewed on a personal computer or similar device.

The electronic publication 1 requires a processor within the hardware for presentation. It is not an independent visual image or document but an application inherent with the publication that can be transmitted electronically through e-mail or downloaded or pass across the Internet.

One of the drawbacks with existing Internet related documents is that they rely on a browser for viewing. The HTML scripts used for web publications and the settings of the browser interact to provide the image viewed by a user. An individual uses browser settings can disrupt the presentation of the text and images as intended by the publisher. Most importantly, such documents often extend below the viewable page according to font settings or the size of the browser window and moving between pages requires a subsequent request and download of a subsequent page.

Publications in other forms such as PowerPoint publications or publications in Word format, Excel format or in the form of “.pdf” files all require application software to be resident on a viewer's machine. This limits the potential distribution of the documents and also causes numerous potential conflicts with a publication through the constant version changes of the applications.

If an electronic publication is sent as a file to a user with any of those applications resident that are compatible with the file, it is also a question of whether or not the particular version they have is compatible with the features of the file as sent.

Another feature of electronic publications is that the file size necessary to use higher order languages or provide files to existing applications is relatively large. Not only is the file size of the publication itself quite large but when bound with the application software itself, the file becomes unreasonably large for transmission. Furthermore, the application software itself requires installation prior to viewing the publication.

In contrast, the present invention provides an electronic publication 1 that contains both the publication and application software for viewing the publication as a single unitary file. The file contains an executable application to address the processor and the operating system of the computer to immediately present the publication without prior installation.

The electronic publication achieves this by providing an executable file written in assembly code to directly address the processor. To keep file size to a minimum, various commands to instruct or compile the graphical presentation of the publication utilize existing subroutines within the operating system.

The preferred embodiment described subsequently is intended to address an Intel processor and Microsoft Windows operating system. However, this does not detract from the generality of the publication or the interface described that can be written to function on a number of different processor and operating system pairs.

In such a manner, an electronic publication of 15 or more pages of images and text as demonstrated in the example in FIGS. 5 to 8 can be provided in a relatively small file size of less than 50 kilo bytes.

It will be appreciated that although the preferred embodiment is generally described with reference to a personal computer and transmitted by email or similar, the invention my also be addressed to other internet capable devices that can receive electronic transmissions provided they have sufficient processing power to execute the application.

The publication provided in the embodiments is a multiple page document. Although the entire document is provided as a unitary file, the amount of content may preclude provision on a single page. In such an instance it is necessary to incorporate a user interface that allows easy and visual appealing transfer between pages of the document. In keeping with existing printed publications, this invention incorporates a user interface that provides a visual page tun to move through the document.

Activation of the page turn can occur through any convenient input means to record an interest from the user to proceed to the next or another page. It may also be provided by an in built automatic tied sequence of requests so that no particular instruction is required by the user. In the preferred form, page tuning is on request with an additional feature for automatic also available. The period for an automatic page turn can be a fixed value or a value changeable by the user. For documents with highly variable quantities of text on each page, the automatic page turn may even be programmed with different timings to display some pages compared with others.

Another feature of the publication as a whole is that the text and images are contained as bitmap files so that the entire screen presentation is scalable without losing content. If the publication 1 as shown in FIG. 4 is resized in its vertical axis, horizontal axis or both, the page as laid out in the publication will stretch or compress along the appropriate axis but no part of the page will move beyond the boundary of the window that may require a scroll bar or similar to view the entire page. Such a feature ensures that the entire page as laid out by an editor or publisher is viewed by a user and any advertising content cannot be lost below the boundaries of the visible window.

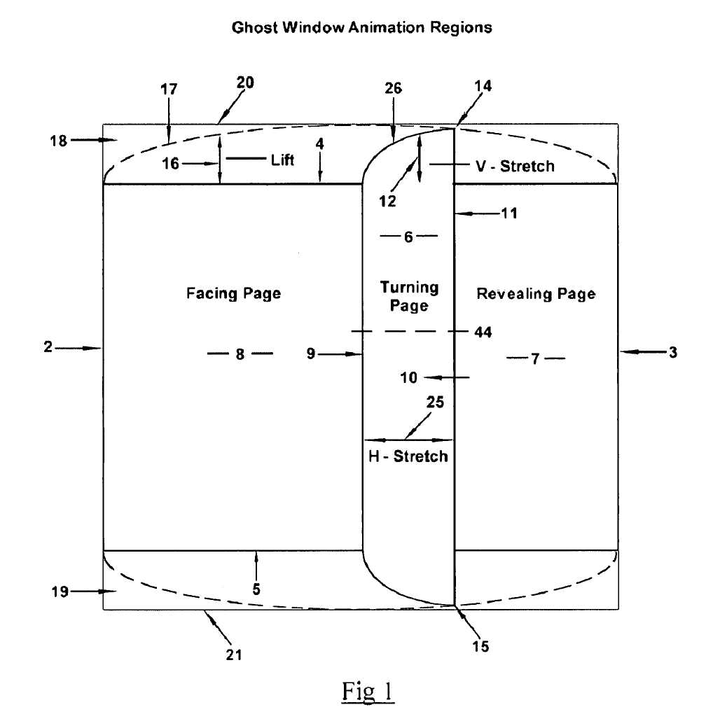

Referring to FIG. 1, the publication incorporates the user interface that has a page-turn facility for the multiple-page document FIG. 1 demonstrates some of the features of the page-turn as will be subsequently described for this preferred embodiment.

Prior to any page-turn, the pages of the publication are bounded by side boundaries 2 and 3 and an upper boundary 4 and a lower boundary 5.

This particular preferred embodiment incorporates a 3-dimensional representation of the page-turn. As a page 6 is turned, it reveals a subsequent page 7. A facing page 8 is already provided prior to the commencement of the page-turn and remains unchanged through the first half of the page-turn sequence. It will be appreciated that as the tuning page 6 passes the axis of rotation 9 when rotating in a direction of arrow 10, the facing page 8 will be progressively hidden beneath the alternate side of the tuning page 6.

Please note that the page-turn described may be used to move forwards or backwards through the document and can move multiple pages in single turn to jump to another location in the document.

In providing an impression of a 3-dimensional animation of the page-turn, it will be appreciated that as the turning page 6 lifts from the revealing page 7, an outer edge 11 distal from the central axis 9 will rotate in an arc that brings that edge 11 closer to the viewer. If an accurate 3-dimensional representation is to be made, there should be some expansion of that edge 11 through its closer proximity to the viewer. Of course, the edge of the page adjacent the central axis 9 remains unchanged throughout the rotation and those portions in between need to be appropriately stretched between the extremes defined by the central axis 9 and the outer edge 11. This is referred to in this invention as vertical stretch as designated by arrow 12 in FIG. 1.

The expansion of the outer edge 11 as defined by corners 14 and 15 define the lift 16 of the page and progress along an elliptical path 17 as shown. It should be noted that this is an expansion of portions of the page both above the upper boundary 4 of the facing page 8 and revealing page 7 and the lower boundary 5.

As the corners 14 and 15 of the turning page follow the elliptical path 17, it will be appreciated that it is necessary to incorporate additional regions 18 and 19 defined by outer boundaries 20 and 21 that are more extensive than the original boundaries of the publication.

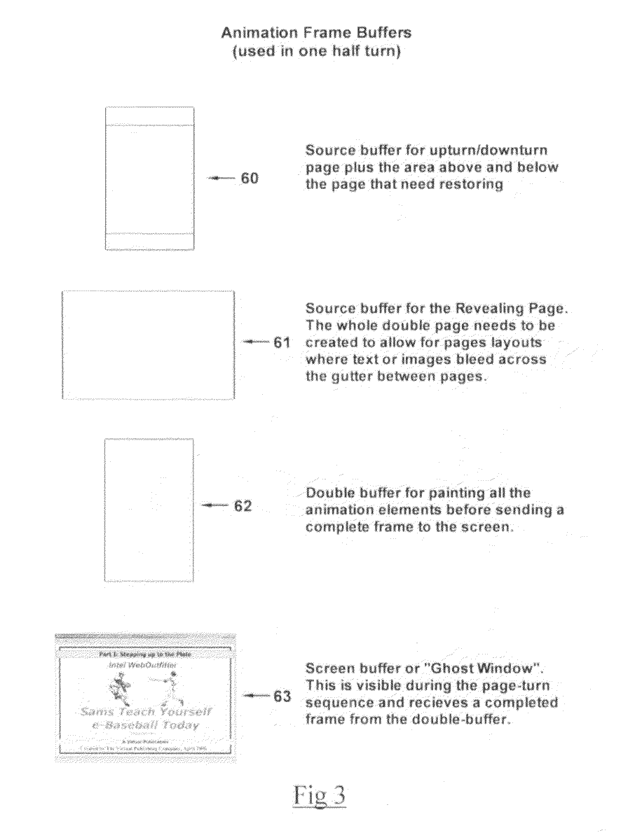

Referring to FIG. 4, it can be seen that the regions 18 and 19 can be at least partially if not fully utilized by border regions 22 and 23 which, if desired, can include a toolbar 24. To provide an accurate animation, the tuning page will overlie these portions progressively during the rotation. Although the publication may be laid out between upper and lower boundaries 4 and 5 initially, the lifted area of the publication as defined by outer boundaries 20 and 21 that is referred to subsequently as the ghost window. When presented as shown in FIG. 3, the unused portions of regions 18 and 19 that are not overwritten with any part of the publication in the screen as described, such as by toolbars or the boundary regions 22 and 23, should still display the wallpaper or other background on the screen if appropriate.

Referring to FIG. 1, it will also be appreciated that as the edge 11 progresses towards the central axis 9, the text or images on the turning page 6 are progressively compressed in the horizontal direction shown by arrow 25.

In this preferred form, the upper and lower edges 26 and 27 of the turning page 6 are also provided as partial elliptical curves as the turning page 6 is not turned as a purely flat surface but kept convex to maximize the presentation of the information on the turning page 6 as it rotates.

If the turning page 6 is no longer a planar page throughout the turn, both the vertical stretch 12 and horizontal stretch 25 are not linear or constant functions across the width of the page. Although leading to greater calculation, such features add to the 3-dimensional reality of the turning page as well as maximizing the exposure of the content on the turning page 6.

It should also be noted that, although the preferred form of the invention uses a convex presentation of the turning page, a concave presentation will also increase the quantity of readable material on the turning page. It is preferred to use a convex presentation as once the turning page passes the central axis and begins to cover the facing page 8, the most legible text or images on the new page revealed on the reverse side of the turning page 6 will be that portion adjacent the left edge of the page. It is this portion that undergoes the minimum compression or stretches towards its normal flat orientation the fastest once the page has passed the central axis 9. It is preferred to provide the maximum readable material on the newly presented page as being the region against the left-hand edge to coincide with the western reading habit of reading from left to right.

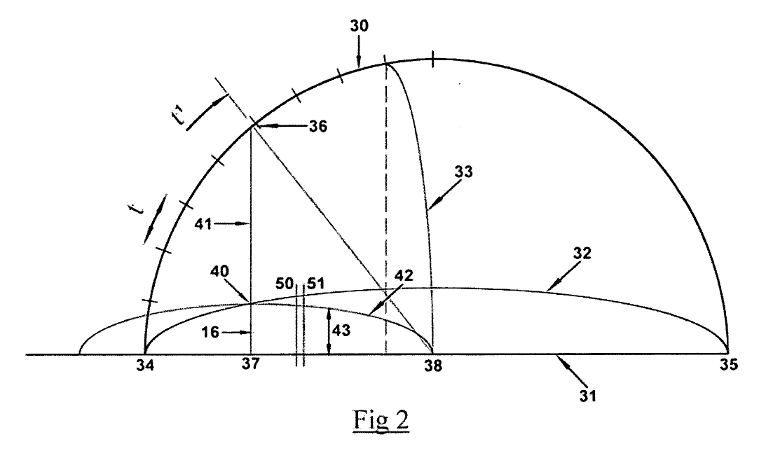

The geometrical calculations of the parameters that control the page-turn are demonstrated in FIG. 2. The algorithm to derive the calculations for the page-turn comes from a continuous equation illustrated in FIG. 2.

As may be appreciated, if the publication was to be viewed from the upper or lower edges of the publication, the outer edge 11 of the page would travel through a semicircle 30 as shown in FIG. 2. If the page is turned at a substantially constant rotational speed, the total time T for rotation of the page can be distributed evenly around the semi-circle 30.

Of course, as the page is being viewed orthogonal to the semi-circle 30, the actual progression of the edge 11 across the revealing page 7, and then again the facing page 8, is represented by the projection of such even time divisions around the semi-circle 30 onto the baseline 31. This leads to a non-linear progression with respect to time of the edge 11 across the revealing page 7 and facing page 8. In effect, the edge 11 seems to speed up in its 2-dimensional progression across the revealing page 7 as it approaches this central axis 9 and slow down again as it continues to progress towards the outer boundary 2 of the facing page 8. The use of a constant travel of the page 11 across the 2-dimensional screen provides an unrealistic appearance to the page-turn, particularly upon takeoff a landing from the revealing page and to the facing page respectively.

The amount of lift 16 given to the outer edge 11 of the page is determined by the progression of the page along the elliptical curve 17. In FIG. 2, this is shown as the elliptical curve 32. It should be noted that the maximum height 33 of that elliptical curve can be a fixed or selectable perimeter. In reality, it represents the proportional distance between the viewer, the outer edge 11 when in line with the central axis 9 and projecting directly out and the width of the page that determines the extra distance to the revealing and facing pages 7 and 8.

It should be noted that this particular embodiment described relates to a page-turn that provides a 3-dimensional visualization on an otherwise 2 dimensional screen presentation. If a similar publication is to be utilized in a virtual 3-dimensional space, the maximum lift 33 can actually be calculated from the proportion of the virtual viewer's position in the 3-dimensional space from the position of the publication and the width of a page.

Still referring to FIG. 2, it will be appreciated that if the semicircle 30 represents the progression of the edge 11 as it travels from one outer edge 3 of the publication to the distal edge 2, the points 34 and 35 which intersect the baseline 31 represent the boundaries 2 and 3 respectively. Hence the distance of the baseline 31 between points 34 and 35 matches the width of the double page as completed.

With the semi-circle 30 representing a time line of total time T for the completion of the page-turn, it can be seen that smaller time divisions t throughout the time line project a non-linear progression along the baseline 31. In this preferred embodiment, the animation is not formed such that a fame is produced at constant time intervals. Instead, frames are produced at a rate consistent with the calculation of the page-turn by the processor and each step in the animation is recalculated according to actual elapsed time t′. As shown in FIG. 2, when the elapsed time t′ represents edge 11 of the turning page being at the point 36, the projection of the point 36 to the baseline 31 determines the width of the turning page. The width of the turning page is the width represented by the distance between the projected point 37 and the baseline 31 and the central axis point 38 that corresponds to the central axis 9 of the publication itself. This can be calculated easily to determine the boundary of the turning page at any instant along the time line 30.

Again, at the instant represented by elapsed time t′, the elliptical curve 32, that is defined by the set or calculated maximum lift 33 and the width of the total publication being the baseline 31 between points 34 and 35, allows the lift 16 that represents the vertical stretch of the outer edge 11 at that instant be calculated. The lift 16 is represented by the line between the projected point 37 on the baseline 31 and the intersection point 40 between the elliptical curve 32 and the line of projection 41.

This geometric set also defines a secondary ellipse 42. The secondary ellipse 42 is a constantly changing ellipse with respect to time. The ellipse 42 is the elliptical curve that is defined by the width of the turning page, being the distance between points 37 and 38, and the lift 16 at that instant in time. The width of the turning page and the lift 16 represent half of the major and minor axes respectively of the elliptical curve 42.

The elliptical curve 42 provides a representation of the amount of vertical stretch of the pixels at any point across the width of the top edge of the turning page. In fact, the vertical stretch shown by arrow 12 in FIG. 1 is the distance between the baseline 31 and the elliptical curve 42 as represented by arrow 43 in FIG. 2. Each point across the width of the top of the page from the outer edge 11, that receives the maximum vertical stretch being the lift 16, and the central point that receives no stretch at all is represented by the corresponding distances 43 from points 37 through to point 38 on the baseline 31.

In fact, the distances 43 and the elliptical curve 42 show the vertical stretch of the upper and lower most pixels on the turning page. The elliptical curve 42 is the same as the elliptical curves 26 and 27 in FIG. 1. As this is a 2-way stretching of the images or text about a horizontal axis 44 shown in FIG. 1, the amount of vertical stretch of a particular pixel is calculated as a proportion of the distance 43 consistent with the proportion of the distance of the particular pixel from the central axis 44 to the upper or lower bodies 26 and 27. For example, a pixel half distant between the central axis 44 and the upper edge of the page 26 should receive 50% of the vertical stretch of the upper edge represented by the arrow 43.

With regard to the horizontal compression or horizontal stretch 25, the calculation is a little more difficult. The horizontal squeeze of a pixel is proportional to the length of secondary ellipse arc to the width of one pixel.

Again referring to FIG. 2, if the turning page 6 was flat rather than convex, it can be seen that the pixels in the horizontal direction would be compressed uniformly for a single animation frame. The degree of compression would be the percentage necessary to fit the total width of the page as represented by the distance between points 34 and 38 on FIG. 2 to the page of reduced width as represented by the distance between points 37 and 38 on FIG. 2.

Of course, with the convex nature of the page, the page is laid out on a curve represented by the secondary ellipse 42. Therefore, the compression of a particular portion of the page as represented by lines 50 and 51 in FIG. 2 is further calculated by the ratio between the length of the line of the secondary ellipse 42 over that portion of the page and bounded by lines 50 and 51 and the length of the baseline 31 between those parallel vertical lines 50 and 51. It will be appreciated that this relative proportion changes constantly along the width of the page.

Having described the geometry of the page-turn, we now need to look at the method of operation of the algorithm itself.

The algorithm utilizes four buffers in the process. These four frame buffers are shown in FIG. 2.

The first buffer 60 contains the flat source image of the turning page. The second source buffer 61 contains the source image with the revealing page. This may be provided as a whole double page to allow for page layouts where the text or images breed across and divide between the pages.

A further buffer 62 is a memory double buffer traditionally used in computer animation to achieve smooth graphics. This buffer duplicates the screen area where the animation is to take place. All the animation elements are painted to the double-buffer before sending a complete frame to the screen. Sending individual paint commands to the screen directly results in an uneven motion because of the refresh rate of the screen being different to the pixel output speed of the processor. This buffer eliminates this by updating the screen with the fastest possible method of a bit-broad memory transfer to the entire frame.

The fourth buffer 63 is the screen buffer or ghost window. This is super imposed over the original window at the point of the page-turn and where all the animation takes place. This buffer is used as the so buffer. In this preferred form that addresses a Windows operating system, use is made of the Windows messaging system. The Windows system is updating screen painting continuously but also doing many, other tasks. Updating a screen paint command is usually a low priority task in the Windows messaging system. Therefore, au efficient way to update the screen with a new image in Windows is to pass Windows the handle of the screen buffer which it uses when it gets around to updating the screen painting.

It is preferred that the program forces an immediate screen paint as soon as the screen buffer has been updated such that Windows will respond by moving the paint command task to the next job in its messaging queue. This allows windows to continue processing all of its other tasks without interruption and yet increases the priority of the paint command to ensure smooth animation.

One other difficulty in providing a good image to the turning page is in avoiding jagged lines, particularly a line such as a diagonal line where the line is interrupted by pixel boundaries.

To overcome this, following calculation of vertical and horizontal pixel movements, it is then necessary to apply anti-aliasing techniques to blend pixel values across boundaries. This is a similar technique to font smoothing.

It should also be appreciated that in compressing the page, it is often necessary to map multiple pixels from the source page to a single pixel in the turning page. To obtain the correct colour values for the pixel in the turning page, it is necessary to average the colours from the multiple source pixels that are addressing the single pixel on the tuning page. Of course, this does not always equate to even pixel boundaries as a single pixel on the turning page is likely to be receiving data from, for example, two whole pixels and a portion of each pixel on either side of those two whole pixels from the source page. The averaging needs to be deterred over the appropriate quantity of pixels to provide the final value.

It should be noted that such matters can be calculated by considering a pixel in the turning page and determine how many pixels from the source page address that pixel or by the reverse of this process. The reverse would consider the pixels from the source page originally and determine where they map onto the turning page.

Referring to FIGS. 5 to 8, a series of screen shots at sequential intervals through the page-turn animation are provided. Each of these screen shots displays the features of the page-turn as described previously.

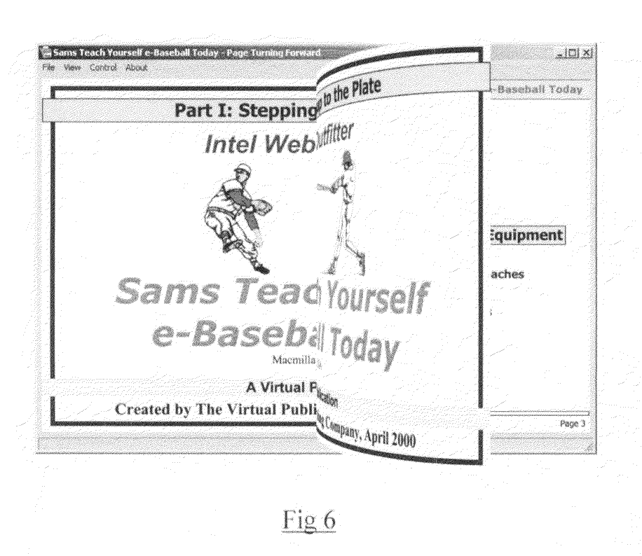

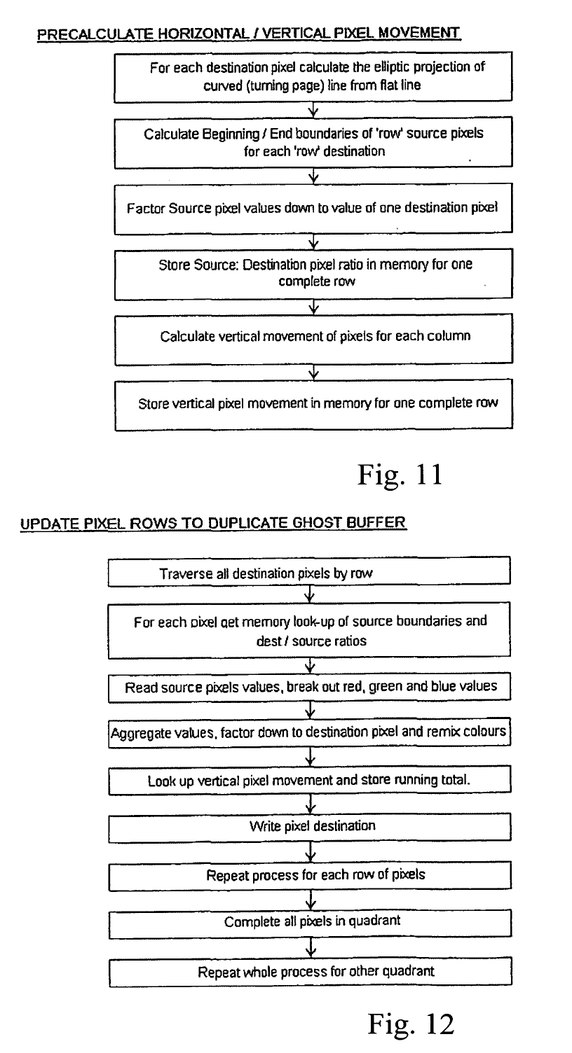

The method of operation of the algorithm for the page-turn is described in the flowcharts from FIG. 9 through to FIG. 14.

Referring firstly to FIG. 9, this explains the overall sequence of events. Once a user initiates a page-turn, the requested page is laid out in a buffer and the page number updated.

The ghost overlay window is displayed and the exact time is recorded.

A upturn buffer being one-half of the ghost window is prepared and the process then seeks to produce the first fame output of the animation. At the end of that frame output, the elapsed time is measured and the next frame of the animation is produced. This is a cyclic process until the turning page has progressed from its starting point to a position directly above the central axis of the document.

At the completion of this upturn sequence, a downturn buffer is created Essentially the process is duplicated in reverse to lay the turning page down over the facing page. The downturn buffer does not need a revealing page and at completion the buffer of the last frame repaint forms the actual window and the ghost window is no longer required.

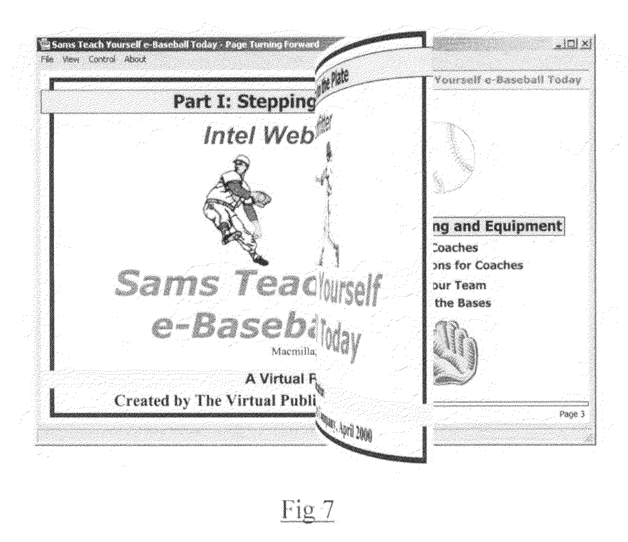

To calculate each frame output, the process is shown in FIG. 10. In that figure, the measured elapsed time is considered so that the frame width based on the time line 30 from FIG. 2 can be calculated. The algorithm then precalculates the horizontal and vertical pixel movement. The page is broken into two so as to represent two quadrants of the double page.

The midpoint pixel is also identified for both the source and destination pages. Calculations can be made from the midpoint pixel row as the horizontal and vertical pixel movement for a row is symmetrical about that midpoint pixel row. The pixel rows are updated to the duplicate ghost buffer and the revealing page is painted. This complete ghost duplicate buffer is then sent for screen painting by the operating system which updates the frame to the screen.

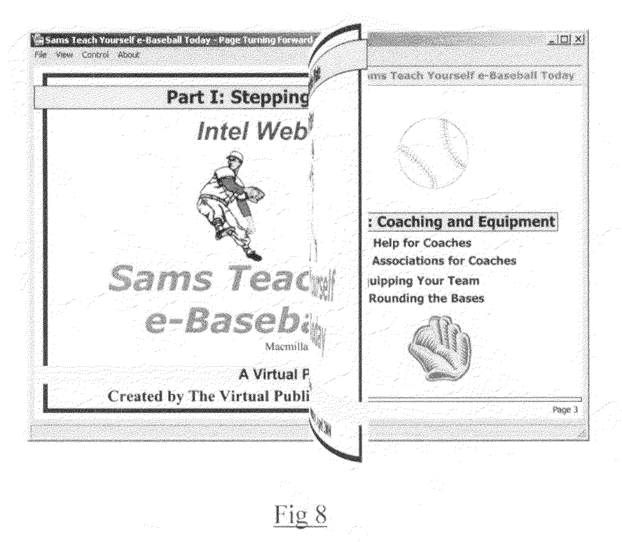

Referring to FIG. 11, the pre-calculation of the horizontal and vertical pixel movement is shown. For each destination pixel, the elliptic projection of the curved turning page line is considered from the flat line. The beginning and end boundaries of the row of sourced pixels are considered for each row of destination pixels. The sourced pixels are factored down to the value of one destination pixel. The algorithm then stores the destination pixel ratio in memory for one complete row.

The algorithm may then calculate vertical movement of pixels for each column and store the vertical pixel movement in memory for one complete row.

Referring to FIG. 11, the updating of pixel rows to the duplicate ghost buffer is explained.

Initially, the algorithm traverses all destination pixels by row. For each pixel the memory looks up the source boundaries and destination source ratios that have been precalculated. The algorithm can read the sourced pixel values and breakout into red, green and blue values.

The algorithm must then aggregate the values for the sourced pixels and factor this down by averaging to the destination pixel and remix the colours.

The algorithm looks up the vertical pixel movement and stores this as a running total so that this can be incremented rather than recalculated in each step. The pixels are then written to their destination and the process repeated for each row of pixels. Once all the pixels are completed in a quadrant, the process can be repeated for the other quadrant.

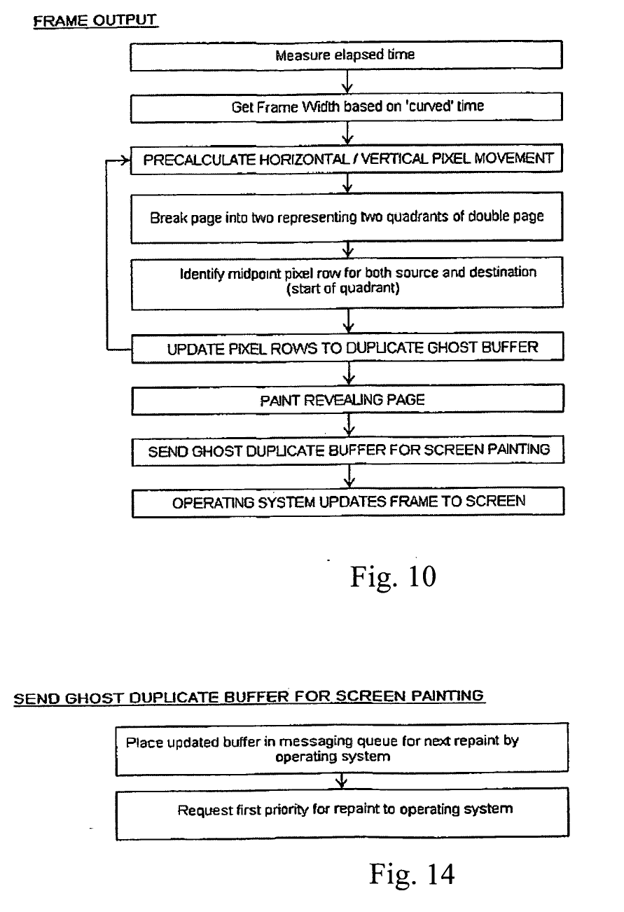

FIG. 13 shows the algorithm steps to paint the revealing page. From the layout page the algorithm calculates the number of pixels in each row to be revealed. This is determined from the page width of the turning page against the backdrop of the revealing page. The algorithm then updates the pixels row by row for the revealing page.

Once the revealing page has also been painted, the ghost duplicate buffer is sent for screen painting. The updated buffer is placed in the messaging queue for the next repaint by the operating system.

As a final step, a priority request is sent for the repaint to the operating system to ensure that the repaint occurs in a timely fashion.

Thus it can be seen that this invention provides an electronic publication with many advantages over the prior art. This includes the user interface that incorporates an animated page-turn.

Although the invention has been described with reference to various preferred embodiments, it will be appreciated that many variations may be applied and specific integers referred to in the description are deemed to incorporate known equivalents where appropriate.

I claim:

1. An electronic publication comprising:
an executable application; and
a document for publication having a plurality of pages;
wherein the application and publication comprise a unitary file in assembly code to address a compatible processor directly and containing a plurality of commands to address sub-routines in a compatible operating system to provide a graphical output of the publication on a display screen.

2. An electronic publication as claimed in claim 1, wherein said hardware processor comprises a microprocessor in one of a computer and an Internet capable device.

3. An electronic publication as claimed in claim 3, wherein said hardware processor comprises a PC compatible microprocessor.

4. An electronic publication as claimed in claim 1, wherein said operating system comprises a Microsoft Windows operating system.

5. An electronic publication as claimed in claim 4, wherein said application provides said publication with a page transition effect in the manner of an animation similar to the turning page of a print publication.

6. An electronic publication as claimed in claim 5, wherein said application addresses said Microsoft Windows operating system to perform the following steps:
requesting a repaint of the display screen;
calculating the elapsed time from initiation of the page-turn animation upon receiving an indication said Microsoft Windows operating system is ready to repaint the screen;
calculating the position of the turning page in accordance with the elapsed time;
instructing said Microsoft Windows operating system to repaint the display screen with a frame of said animation; and
requesting a further repaint of the display screen.

7. An electronic publication as claimed in claim 6, wherein the turning page is stretched in a direction parallel to the axis of its rotation and compressed in a direction orthogonal to its axis of rotation and the quantity of stretch and compression is calculated in accordance with one of the position of the turning page, and said elapsed time, in a frame of said animation.

8. An electronic publication as claimed in claim 5, wherein at least one of an image and text on a turning page of said animation is calculated on a pixel by pixel basis by mapping pixels from a prior frame of said animation to corresponding positions on said turning page.

9. A method of providing an electronic publication comprising:
producing an executable application;
producing a document for publication containing a plurality of pages; and
distributing said electronic publication as a unitary file comprising both said application and said document for publication;
wherein said application presents said electronic publication as a graphical output on a display screen including a page transition effect between a first page and a subsequent page in the form of an animation of a turning page.

10. A method of providing an electronic publication as claimed in claim 8, wherein said application is in assembly code to address a compatible processor directly and containing a plurality of commands to address sub-routines in a compatible operating system to provide a graphical output of the publication on a display screen.
